(19) United States
(12) Patent Application Publication
(10) Pub. No.: US 2020/0329002 A1
(43) Pub. Date: Oct. 15, 2020

(54) COMPUTER METHOD AND APPARATUS FOR MANAGING HASHTAGS AND OTHER MESSAGE METADATA

(71) Applicant: DOS CENTAVOS, LLC, EVERETT, WA (US)

(72) Inventor: CHRISTOPHER A. WIKLOF, EVERETT, WA (US)

(21) Appl. No.: 16/847,180

(22) Filed: Apr. 13, 2020

Related U.S. Application Data
(60) Provisional application No. 62/832,395, filed on Apr. 11, 2019.

(51) Int. Cl. H04L 12/58

(52) U.S. Cl. CPC H04L 51/18; H04L 51/32

(57) ABSTRACT

A computer method includes identifying, with a message augmentation system, message characteristics associated with a plurality of messages, and recording, with the message augmentation system, the message characteristics on one or more blockchains. The computer method includes identifying one or more characteristics of a current message of a user of the message augmentation system by analyzing the current message with the message augmentation system, and identifying, with the message augmentation system, a candidate message augmentation for the current message by querying the one or more blockchains based on the characteristics of the current message. The computer method includes assisting the user to augment the current message with the candidate message augmentation. Systems, devices, and methods are disclosed for prompting users to select hashtags to associate with content. A system, device, and method for assigning hashtags to social media content based on sensed parameters. Systems, devices, and methods provide for populating a hashtag database and assigning one or more hashtags to content.

### CROSS REFERENCE TO RELATED APPLICATIONS

The present application claims priority benefit from co-pending U.S. Provisional Patent Application No. 62/832,395, entitled “METADATA ENHANCEMENT FOR ELECTRONIC COMMUNICATIONS,” filed Apr. 11, 2019 (docket number 2581-017-02), which, to the extent not inconsistent with the disclosure herein, is incorporated by reference.

### SUMMARY

According to an embodiment, a computer method includes identifying, with a message augmentation system, message characteristics associated with a plurality of messages. The computer method includes recording, with the message augmentation system, the message characteristics in one or more non-transitory computer readable memories. The computer method includes identifying one or more characteristics of a current message of a user of the message augmentation system by analyzing the current message with the message augmentation system. The computer method includes identifying, with the message augmentation system, a candidate message augmentation for the current message by querying the one or more non-transitory computer readable memories based on the characteristics of the current message. The computer method includes assisting the user to augment the current message with the candidate message augmentation. According to embodiments, the message characteristics are recorded at an encrypted memory location, the memory location being held in at least one blockchain carried by the non-transitory computer readable memories, and the candidate message augmentation for the current message is identified by querying at least one blockchain carried by the non-transitory computer readable memories.

According to an embodiment, the computer method further includes assisting the user to augment the current message with the candidate message augmentation before the current message has been sent.

According to an embodiment, the computer method further includes updating the blockchain with content from the current message after the current message has been augmented with the candidate message augmentation and after the current message has been sent.

According to an embodiment, a computer method for augmenting message content includes receiving first message data into a computer memory. The computer method includes analyzing the first message data to derive first message characteristics corresponding to the first message data. The computer method includes reading a plurality of second message characteristics from one or more computer memories. The computer method includes matching the first message characteristics to the second message characteristics to determine one or more best matches. The computer method includes selecting one or more message augmentation candidates derived from the one or more best matches. The computer method includes augmenting the first message with the one or more message augmentation candidates. The computer method includes transmitting the first message including the message augmentation. The computer method includes writing the first message characteristics to the one or more computer memories holding the second message characteristics and/or the blockchain.

Metadata, such as hashtags, provides a tool for users to associate social media content (e.g., post/status/tweet) to a topic, category, and/or digital “conversation.” According to embodiments, computer methods may be used to enhance metadata and/or prompt a user to use metadata that categorizes social media content, which may include videos, photos, text, audio recordings, or otherwise. The metadata may then be searched or sorted by the user or an electronic agent of the user to extract social media content that is relevant to the topic, category, and/or digital conversation by searching or filtering for social media content that includes the metadata.

According to an embodiment, a computer method for reducing computer search processing to identify related content includes receiving or generating an electronic message with a user device, receiving or generating identification data corresponding to a sensed parameter of the user device, performing at least one database query including the sensed parameter data as an argument, and receiving at least one database query response including predetermined metadata. The predetermined metadata is rendered to a display of the user device to prompt a user to select one or more predetermined metadata values corresponding to the predetermined metadata.

According to an embodiment, a mobile device includes an image sensor, a wireless radio, a display, and a processing logic circuit communicatively coupled to the wireless radio and configured to initiate image captures using the image sensor and to receive images from the image sensor, the processing logic circuit further coupled to render display images to the display. A memory coupled to be read by the processing logic circuit includes instructions that, when executed, will cause the mobile device to perform operations including capturing a video with the image sensor, sensing a geolocation of the mobile device while the image sensor is capturing the video, receiving a user-input to live stream the video as a live stream video, and transmitting, using the wireless radio, the live stream video and the geolocation to a computing device. The processing logic circuit is further configured to receive metadata from the computing device, wherein the metadata corresponds to the geolocation location, render the metadata to the display of the mobile device while the mobile device continues to capture the video and transmits the video as a live stream video, receive a user-selection of one or more user-selected hashtag(s) from the metadata, and transmit the user-selected hashtags as live stream metadata in the live stream video.

According to an embodiment, a method for reducing computer search processing to identify related content includes receiving content generated by a user device, receiving identification data corresponding to a sensed parameter of the user device, the sensed parameter being sensed by the user device when the content was captured or transmitted by the user device, performing at least one database query including the sensed parameter data as an argument, receiving at least one database query response including predetermined hashtag data, and transmitting the predetermined hashtag data to the user device for rendering to a display of the user device to prompt a user to select one or more predetermined hashtags corresponding to the predetermined hashtag data.

According to an embodiment, a method of automatically adding hashtags to incoming live stream videos includes receiving live stream videos having metadata including hashtags indicating that the live stream videos were captured proximate to a first geolocation and within a first time period, ranking the hashtags from a most frequently used hashtag to a least frequently used hashtag, receiving an additional live stream video having additional metadata indicating that the additional live stream video was captured proximate to the first geolocation, and appending the most frequently used hashtag to the additional live stream video.

According to an embodiment, a method for reducing computer search processing to identify related video content includes receiving a first live stream video generated by a first user device, wherein the first live stream video includes first metadata having a first hashtag, receiving a second live stream video generated by a second user device, wherein the second live stream video includes second metadata having a second hashtag, receiving a third live stream video generated by a third user device, wherein the third live stream video includes third metadata having a third hashtag, and wherein the first, second, and third metadata indicate that the first, second, and third live stream videos were captured proximate to a first geolocation and within a time period, receiving a fourth live stream video, wherein the fourth live stream video includes fourth metadata, and appending at least one of the first hashtag, the second hashtag, or the third hashtag to the fourth live stream video when the fourth metadata indicates that the fourth live stream video was captured proximate to the first geolocation.

According to an embodiment, a method for reducing computer search processing to identify related video content includes receiving a live stream video generated by a user device, receiving identification data corresponding to a sensed parameter of the user device, the sensed parameter being sensed while the live stream video is captured by the user device, performing at least one database query including the sensed parameter data as an argument, and receiving at least one database query response including predetermined hashtag data. The method may further include identifying at least one subscriber of the live stream video based at least in part on the predetermined hashtag data, wherein the at least one subscriber is associated with the predetermined hashtag data, and transmitting the live stream video to at least one subscriber device that is linked to the at least one subscriber.

According to an embodiment, a method for automatically assigning hashtag metadata to live video stream content and distributing the live video stream content to subscribers according to the automatically assigned hashtag metadata includes capturing, with a user device, a video, transmitting, from the user device, the video to a computer server as a live stream video, and receiving, by the computer server, the live stream video, wherein the live stream video includes sensed parameters of the user device, the sensed parameters being sensed while the live stream video was captured by the user device. The computer server performs at least one database query including the sensed parameter data as an argument, receives at least one database query response including predetermined hashtag data, identifies at least one subscriber of the live stream video based at least in part on the predetermined hashtag data, wherein the at least one subscriber is associated with the predetermined hashtag data, and transmits the live stream video to at least one subscriber device that is linked to the at least one subscriber.

According to an embodiment, a method of populating and utilizing a database with hashtags for a pre-planned event includes receiving an entry for a hashtag database, wherein the entry includes a hashtag associated with an upcoming event and at least one parameter value associated with the upcoming event and storing the entry in the hashtag database. The method may include subsequently receiving content and metadata corresponding to the content generated by a user device, the metadata including at least one second parameter value. The hashtag database is queried with the second parameter value as an argument in the query and responds with the hashtag corresponding to the parameter value. The method includes adding the hashtag to the metadata for the received content, wherein the second parameter value has a correspondence to the parameter value.

According to an embodiment, a method for automatically assigning hashtag metadata to content includes receiving image content generated by a user device, performing image analysis on the image content, wherein the image analysis includes matching at least a portion of the image content to images in a database, and linking the image content to a matching hashtag when at least a portion of the image content matches a matching image in the database, wherein the matching hashtag is associated with the matching image.

According to an embodiment, a method for automatically assigning hashtag metadata to content includes receiving social media content generated by a user device, the social media content including text, performing text analysis on the social media content, wherein the text analysis includes matching at least a portion of the text to a matching keyword in a database, and linking the social media content to a matching hashtag when at least a portion of the text of the social media content matches a matching keyword in the database, wherein the matching hashtag is associated with the matching keyword.

According to an embodiment, a computer method for providing user control of personal data includes receiving, into a server computer, a use context and a user designation of personal data via a graphical user interface (GUI), encrypting the personal data with a data storage encryption key, and hashing the encrypted data using hashing rules to obtain a hash (link) for identifying a corresponding data storage location in a distributed file system. The computer method may include saving the encrypted data at the hash (link) location in the distributed file system, and recording data corresponding to the hash (link) as an operation return value in a blockchain transaction having a transaction ID. The computer method may include encoding the use context and the blockchain transaction ID in a metadata object, and storing the metadata object.

According to an embodiment, a computer method for providing user control of personal data includes receiving, into a server computer, a user input via the GUI indicating a use context for personal data, reading a metadata object to obtain a blockchain transaction ID corresponding to the use context, and reading a blockchain transaction corresponding to the blockchain transaction ID to obtain an operation return value. The computer method may further include converting the operation return value to a hash (link), reading the data from a distributed file system at the hash (link) location. The computer method may optionally include unpacking the hashed data using hashing rules. The computer method may decrypting the unpacked data with the data storage encryption key to produce the personal data and outputting at least a portion of the personal data to a designee identified by the user via the GUI.

### BRIEF DESCRIPTION OF THE DRAWINGS

FIG. 1 is a flow chart showing a computer method, according to an embodiment.

FIG. 2 is a flow chart showing a computer method for augmenting message content, according to an embodiment.

FIG. 3 shows a flow chart illustrating an example process of hashtag prompting for a live stream video, according to an embodiment.

FIG. 4 illustrates an example system for facilitating hashtag prompting, according to an embodiment.

FIG. 5 illustrates an example computing device for facilitating hashtag prompting, according to an embodiment.

FIGS. 6A and 6B illustrate an example mobile device for facilitating hashtag prompting, according to an embodiment.

FIG. 7A shows a flow chart illustrating an example process of assigning hashtags to received content, according to an embodiment.

FIG. 7B shows a flow chart illustrating an example process of assigning hashtags to received content, according to an embodiment.

FIG. 8 illustrates an example system for facilitating hashtag assignment, according to an embodiment.

FIG. 9 illustrates an example computing device for facilitating hashtag assignment, according to an embodiment.

FIG. 10 illustrates example entries in a database for facilitating hashtag assignment, according to an embodiment.

FIG. 11A shows a flow chart illustrating an example process of assigning hashtags to received content based on images in the content, according to an embodiment.

FIG. 11B shows a flow chart illustrating an example process of assigning hashtags to received content based on text in the content, according to an embodiment.

FIG. 12 illustrates an example system for facilitating hashtag assignment, according to an embodiment.

FIG. 13 illustrates an example computing device for facilitating hashtag assignment, according to an embodiment.

FIG. 14 illustrates example entries in a database for facilitating hashtag assignment, according to an embodiment.

FIG. 15 shows a flow chart illustrating an example process of populating and utilizing a database with hashtags for a pre-planned event, according to an embodiment.

FIG. 16 shows a flow chart illustrating a computer method for saving personal data, according to an embodiment.

FIG. 17 shows a flow chart illustrating a computer method for retrieving saved personal data, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

While the term “hashtag” is used herein, it is to be understood, unless context dictates otherwise, that the “hashtag” referenced herein shall refer to message metadata, whether encoded within message payload data (as per typical hashtag use) or within message header or envelope structure.

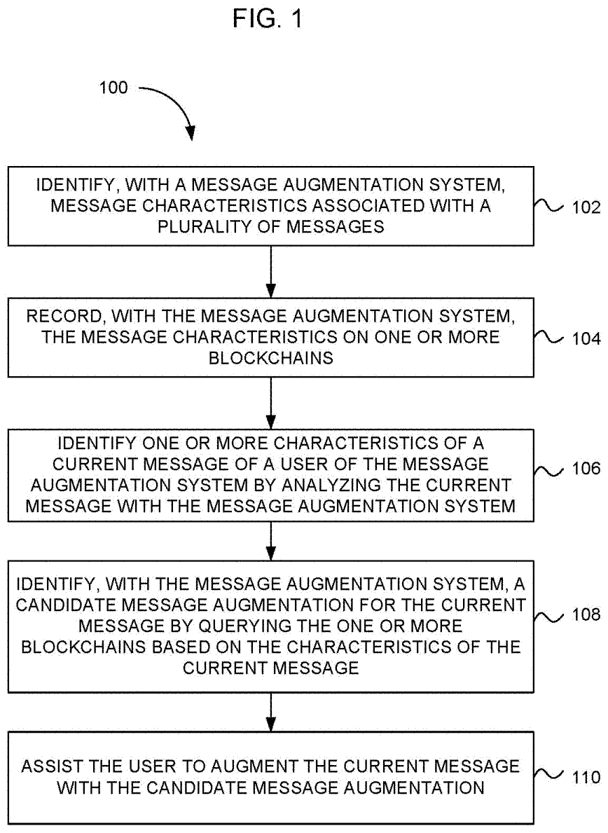

FIG. 1 is a flow chart showing a computer method 100 for using a blockchain data structure to carry reference hashtag assignments correlated to previous message characteristics and assigning or proposing addition of a reference hashtag to a current message corresponding to its new message characteristic, based on similarity of new message characteristic metadata to previous message characteristic metadata, according to an embodiment.

According to an embodiment, a computer method 100 includes, in step 102, identifying, with a message augmentation system, message characteristics including one or more of a message label such as a hashtag associated with the message, a location associated with the message, a recipient of the message, words in text of the message, and whether the message includes an image, audio, a video, and/or a gif associated with a plurality of messages. Step 104 includes recording, with the message augmentation system, the message characteristics on one or more blockchains. Step 106 includes identifying one or more characteristics of a current message of a user of the message augmentation system by analyzing the current message with the message augmentation system. Step 108 includes identifying, with the message augmentation system, a candidate message augmentation for the current message by querying the one or more blockchains based on the characteristics of the current message. Step 110 includes assisting the user to augment the current message with the candidate message augmentation.

As used herein, the term “text of the message” shall be understood to refer to message content generally. For example, a video message does not necessarily carry any text, other than bitmapped video representation of text that falls within the video payload. But the term does not refer merely to text that may fall within a video frame, but rather an entirety of the video payload data package.

In an embodiment, recording, with the message augmentation system, the message characteristics on one or more non-transitory computer readable memories in step 104, may include recording, with the message augmentation system, the message characteristics in one or more computer readable memory locations identified by one or more blockchain transactions. Additionally, identifying, with the message augmentation system, a candidate message augmentation for the current message by querying the one or more non-transitory computer readable memories based on the characteristics of the current message at step 108, may include identifying, with the message augmentation system, a candidate message augmentation for the current message by querying the one or more computer readable memory locations identified by the one or more blockchain transactions based on the characteristics of the current message.

In an embodiment, the one or more blockchains may include a public blockchain. In an embodiment, the one or more computer readable memory locations include a distributed file system. For example, a distributed file system may include an interplanetary file system (IPFS), a FileCoin system, and/or a server service that provides access to IPFS or FileCoin.

According to embodiments, the use of a blockchain to mediate access to data corresponding to message augmentation may be generalized to include other types of personal data such as, for example, personal health records, personal contacts, personal product or service preferences, banking records, and/or other personal data to which a user prefers to hold custody. For example, a user may prefer to hold custody of data rather than entrusting such custody to a third party, which may use the data in unauthorized or non-preferred ways.

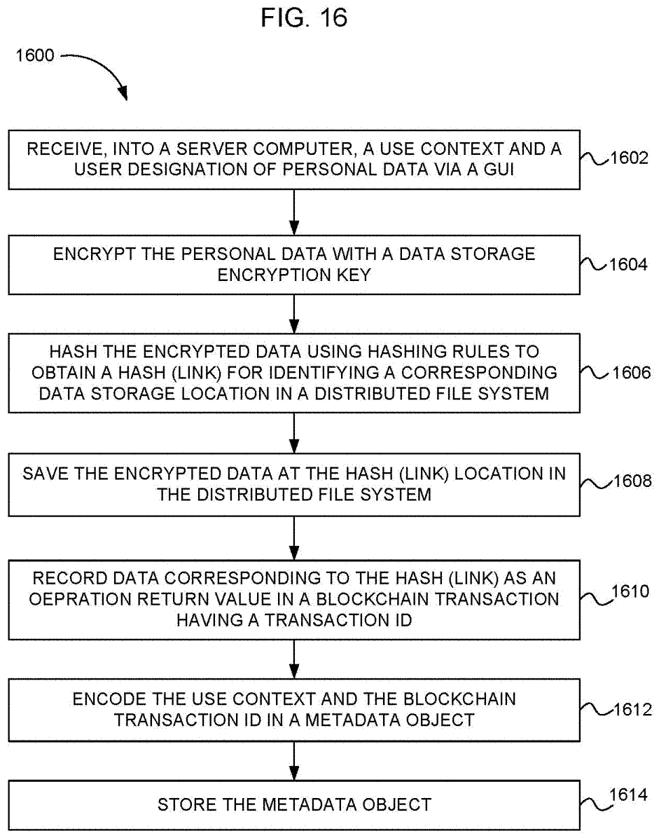

FIG. 16 shows a flow chart illustrating a computer method 1600 for saving personal data, according to an embodiment.

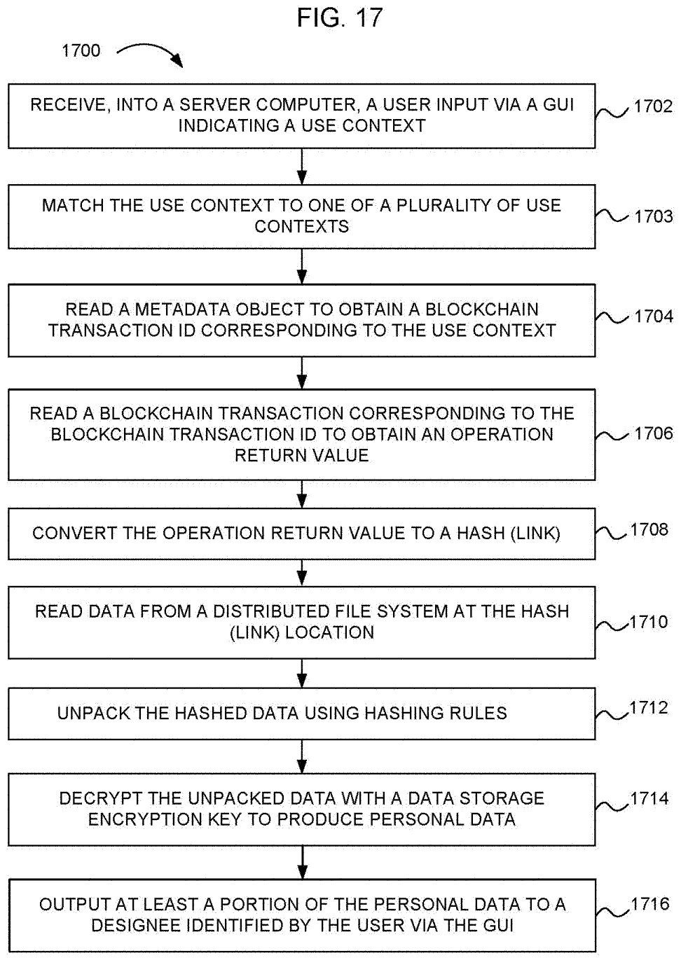

FIG. 17 shows a flow chart illustrating a computer method 1700 for retrieving saved personal data, according to an embodiment.

Referring to FIG. 16, according to an embodiment, a computer method 1600 for providing user control of personal data includes, in step 1602, receiving, into a server computer, a use context and a user designation of personal data via a graphical user interface (GUI). Step 1604 includes encrypting the personal data with a data storage encryption key. Step 1606 includes hashing the encrypted data using hashing rules to obtain a hash (link) for identifying a corresponding data storage location in a distributed file system. Step 1608 includes saving the encrypted data at the hash (link) location in the distributed file system. Step 1610 includes recording data corresponding to the hash (link) as an operation return value in a blockchain transaction having a transaction ID. Step 1612 includes encoding the use context and the blockchain transaction ID in a metadata object. Step 1614 includes storing the metadata object.

Referring to FIG. 17, according to an embodiment, a computer method 1700 includes, in step 1702, receiving, into the server computer, a user input via the GUI indicating a use context. Step 1704 includes reading the metadata object to obtain the blockchain transaction ID corresponding to the use context. Step 1706 includes reading the blockchain transaction corresponding to the blockchain transaction ID to obtain the operation return value. Step 1708 includes converting the operation return value to the hash (link). Step 1710 includes reading the data from the distributed file system at the hash (link) location. Step 1712 includes unpacking the hashed data using the hashing rules. Step 1714 includes decrypting the unpacked data with the data storage encryption key to produce the personal data. Step 1716 includes outputting at least a portion of the personal data to a designee identified by the user via the GUI.

According to an embodiment, the computer method 1700 further includes, in step 1703, matching the use context to one of a plurality of use contexts. Reading the metadata object to obtain the blockchain transaction ID, in step 1704, may include reading a blockchain transaction ID corresponding to a matched subset of blockchain transaction IDs. Various use contexts are contemplated. According to examples herein, a use context includes provision of hashtags or other message metadata to a user. In another example, a use context may include providing personal medical records to a health services supplier or an insurance company. In another example, a use context may include applying for a loan, where the loan application requires banking information. In another example, a use context may include electronically communicating with a person or persons whose identities and/or communication coordinates are kept in user custody.

In an embodiment, the blockchain may include a public blockchain. In another embodiment, the distributed file system comprises IPFS.

Referring again to FIG. 16, according to an embodiment, the computer method 1600 includes, prior to storing the metadata object in step 1614, encrypting the metadata object with the data storage encryption key or with a different metadata encryption key.

According to an embodiment, in FIG. 16, the computer method 1600 further includes encrypting the hash (link). Recording data corresponding to the hash (link) as the operation return value in the blockchain transaction having the transaction ID, in step 1610, includes recording the encrypted hash (link) as the operation return value in the blockchain transaction having the transaction ID.

According to an embodiment, encoding the use context and the blockchain transaction ID in a metadata object, in step 1612, includes encrypting the blockchain transaction ID with a blockchain encryption key, and writing the encrypted blockchain transaction ID to the metadata object.

Returning again to the use case of message augmentation, in FIG. 1, in an embodiment, identifying the candidate message augmentation, in step 108, includes selecting one or more characteristics of the current message, identifying one or more messages from the one or more computer readable memories that include characteristics related to the one or more characteristics of the current message, and identifying, from the one or more messages from the one or more computer readable memories, content not yet included in the current message that may be relevant to include in the current message.

In an embodiment, assisting the user to augment the current message, in step 110, includes prompting the user to add the candidate message augmentation to the current message. In an embodiment, assisting the user to augment the current message, in step 110, includes prompting the user to approve the candidate message augmentation, and augmenting the current message with the candidate message augmentation upon receiving approval from the user.

In an embodiment, assisting the user to augment the current message, in step 110, includes automatically augmenting the current message for the user. The current message may be a text message. The current message may be a multimedia message. The current message may be an email. In an embodiment, the messages include messages sent from a plurality of different messaging applications. The messages may include text messages. The messages may include multimedia messages. The messages may include emails.

According to an embodiment, the computer method 100 further includes assisting the user to augment the current message with the candidate message augmentation before the current message has been sent.

According to an embodiment, the computer method 100 further includes updating the blockchain with content from the current message after the current message has been augmented with the candidate message augmentation and after the current message has been sent.

In an embodiment, the message characteristics include content metadata associated with the messages. In an embodiment, the message characteristics include message labels. The message labels may include hashtags. The candidate message augmentation may include a hashtag.

Location

In an embodiment, the message characteristics include locations associated with the messages. In an embodiment, identifying the candidate message augmentation, in step 108, includes identifying a current location of the user, and identifying one or more common message characteristics of messages sent by other users from the current location of the user.

In an embodiment, identifying the candidate message augmentation, in step 108, includes identifying the one or more common message characteristics of messages sent by other users from the current location of the user within a selected recent timeframe.

In an embodiment, identifying the candidate message augmentation, in step 108, includes identifying the current location of the user, and identifying the one or more common message characteristics of messages sent previously by the user from the current location.

In an embodiment, the candidate message augmentation includes adding the one or more common message characteristics to the current message.

Date

In an embodiment, the message characteristics include dates that the messages were sent.

In an embodiment, the candidate message augmentation includes adding a message characteristic associated with a current date. In an embodiment, the message characteristics may include times that the messages were sent. In an embodiment, the candidate message augmentation may include adding a message characteristic associated with a current time.

Abstracted Content

In an embodiment, the message characteristics may include nouns included in the text of the messages. In an embodiment, the candidate message augmentation includes adding a message characteristic associated with a noun included in the current message.

In an embodiment, the message characteristics may include verbs included in the text of the messages. In an embodiment, the candidate message augmentation includes adding a message characteristic associated with a verb included in the current message.

In an embodiment, the message characteristics may include subjects of phrases included in the text of the messages. In an embodiment, the candidate message augmentation includes adding a message characteristic associated with a subject of a sentence included in the current message.

In an embodiment, the message characteristics may include objects of phrases included in the text of the messages. In an embodiment, the candidate message augmentation includes adding a message characteristic associated with an object of a sentence included in the current message.

In an embodiment, the message characteristics may include images included in the messages. In an embodiment, the candidate message augmentation includes adding an image to the current message. In an embodiment, the candidate message augmentation includes adding a same image sent or received previously by the current user. In an embodiment, the candidate message augmentation includes adding an image associated with a characteristic of the current message.

In an embodiment, the message characteristics may include audio clips included in the messages. In an embodiment, the candidate message augmentation includes adding an audio clip to the current message. In an embodiment, the candidate message augmentation includes adding a same audio clip sent or received previously by the current user. In an embodiment, the candidate message augmentation includes adding an audio clip associated with a characteristic of the current message.

In an embodiment, the message characteristics may include video clips included in the messages. In an embodiment, the candidate message augmentation includes adding a video clip to the current message. In an embodiment, the candidate message augmentation includes adding a same video clip sent or received previously by the current user. In an embodiment, the candidate message augmentation includes adding a video clip associated with a characteristic of the current message.

System Configuration

In an embodiment, at least a portion of the message augmentation system is implemented on an electronic device of the user. In an embodiment, at least a portion of the message augmentation system is implemented in a cloud computing environment. In an embodiment, the user is a subscriber to the message augmentation system. In an embodiment, the messages are messages in which at least one of a sender or a receiver is the subscriber to the message augmentation system.

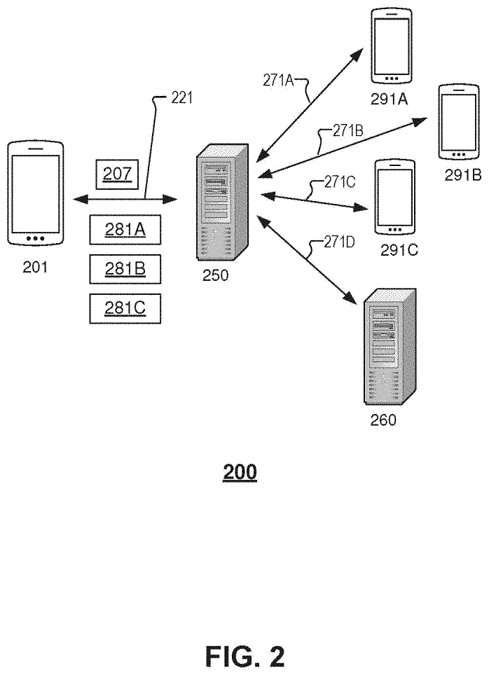

FIG. 2 is a flow chart showing a computer method 200 for augmenting message content, according to an embodiment.

According to an embodiment, a computer method 200 for augmenting message content includes, in step 202, receiving first message data into a computer memory. Step 204 includes analyzing the first message data to derive first message characteristics corresponding to the first message data. Step 206 includes reading a plurality of second message characteristics from one or more computer memories. Step 208 includes matching the first message characteristics to the second message characteristics to determine one or more best matches. Step 210 includes selecting one or more message augmentation candidates derived from the one or more best matches. Step 212 includes augmenting the first message with the one or more message augmentation candidates. Step 214 includes transmitting the first message that includes the message augmentation.

In an embodiment, receiving first message data into the computer memory, in step 202, includes receiving the message data from a user via a user interface.

In an embodiment, analyzing the first message data, in step 204, includes identifying hashtags embedded in the message or associated with the message.

In an embodiment, selecting one or more message augmentation candidates, in step 210, includes selecting one or more hashtags previously embedded in or associated with previously received messages.

In an embodiment, augmenting the first message, in step 212, includes assisting the user to augment the first message.

In an embodiment, augmenting the first message, in step 212, includes proposing one or more message augmentation candidates to the user via the user interface, and receiving an acceptance of one or more message augmentation candidates from the user via the user interface.

In an embodiment, reading a plurality of second message characteristics, in step 206, includes decrypting and reading data from a blockchain that carries previously received second messages or second message characteristics.

According to an embodiment, the computer method 200 includes, in step 216, writing the first message characteristics to the one or more computer memories holding the second message characteristics. In an embodiment, step 216 further includes writing the first message characteristics to the blockchain.

As described above, metadata provides a tool for users to associate social media content, streamed (over-the-top (OTT)) media and/or other digitally transmitted content to a topic, category, and/or digital “conversation.” One popular form of metadata can be expressed as a “hashtag,” an alphanumeric string delimited by a leading “hash sign” (#) and a trailing space. Embodiments herein may be applicable to plural forms of metadata. For ease of understanding, unless context indicates to the contrary, the various forms of metadata for which the disclosed enhancements are applicable are described herein as “hashtags.”

At times, a hashtag attains critical mass (enough people use the same hashtag) and becomes mainstream as a way to associate with cultural issues, political topics, events, local policies, and otherwise. Hence, users often desire to associate their social media content with one or more of the mainstream hashtags.

In some contexts, an “official hashtag” is identified or otherwise promoted by political candidates, corporations, television shows, event promoters, and otherwise. Here again, users may desire to associate their social media with an official hashtag that is being promoted or reserved in order to join the digital conversation represented by the official hashtag.

Additionally or alternatively, a hashtag may be used to provide specificity to transmit a message from one user to another intended user.

In the context of live video streaming, switching applications may be particularly cumbersome. Users may use mobile devices with a rear-facing camera to capture a video in a mobile social media application and simultaneously live stream the video as a live stream video to a server used by the social media application. However, users who are filming a video and live streaming a video use a display of the mobile device as a viewfinder for the video. Hence, switching out of an application to insert or search for a hashtag to insert may interrupt the filming of the video that will be, or is being, live streamed as a live stream video.

At times, users may not know a mainstream or official hashtag that corresponds to the content of their social media content, although it may be desirable to associate the social media content with mainstream or official hashtags that are not (at least initially) included in the social media content.

According to embodiments, a system, device, and method for providing or prompting a user to use a hashtag are disclosed. In an embodiment, the user is prompted to select between different hashtags rendered to a display of a mobile device while the user is live streaming a video. The hashtag(s) that the user is prompted to select may be a crowd-sourced hashtag or may be provided by an organizer or promoter of an event. Although many of the examples in this disclosure are relevant to live stream video, those skilled in the art appreciate that the disclosed techniques directed to hashtag prompting can also be applied to other content such as photographs, text, and audio.

A system, device, and method for assigning hashtags to received content are disclosed. In an embodiment, a server computer receives social media content from a user device and assigns one or more hashtags to the social media content based at least in part on a geolocation of the social media content and/or a time stamp of the social media content. A database may have entries that link certain hashtags with the geolocations and/or the time stamps, and the server computer can query the database and assign the certain hashtags to the social media content based on the entries. The server computer may transmit the social media content to subscribers of the certain hashtags based on the assignment of a hashtag to the social media content.

The entries in the database may be crowd-sourced or may be provided by an organizer or promoter of an event, for example. Although some of the examples in this disclosure are relevant to live stream video, those skilled in the art appreciate that the disclosed techniques directed to hashtag assignment can also be applied to other content such as photographs, text, and audio.

In an embodiment, a system, device, and method for assigning hashtags to received/generated content based on the images or text in the received or generated content is disclosed. In an embodiment, a server computer receives social media content from a user device and assigns one or more hashtags to the social media content based at least in part on (1) a geolocation of the social media content, (2) a time stamp of the social media content, (3) image analysis of the social media content, and/or (4) text analysis of the social media content. A database may have entries that link certain hashtags with the geolocations, time stamps, images, and/or text, and the server can query the database and assign the certain hashtags to the social media content based on the entries. The server computer may transmit the social media content to subscribers of the certain hashtags based on the assignment of the hashtag to the social media content.

The entries in the database may be crowd-sourced or may be provided by an organizer or promoter of an event, for example. Although some of the examples in this disclosure are relevant to live stream video, those skilled in the art appreciate that the disclosed techniques directed to hashtag assignment can also be applied to other content such as photographs, text, and audio.

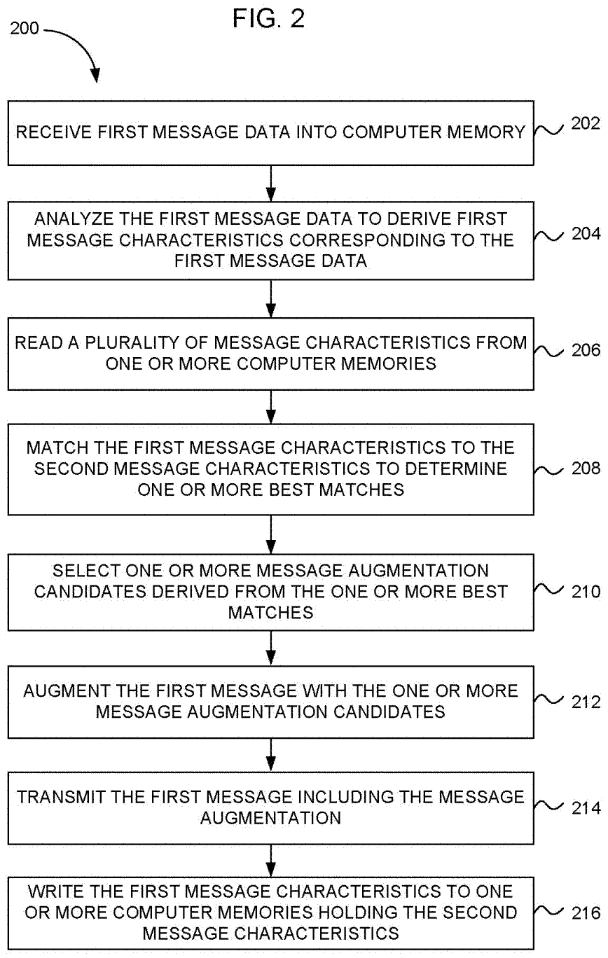

FIG. 3 shows a flow chart illustrating an example process 300 of hashtag prompting for a live stream video, according to an embodiment of the disclosure. In an embodiment, the process 300 is executed by a server computer. In another embodiment, the process 300 may be executed by a personal electronic device or a personal computer operatively coupled to a network.

In process block 305, the live stream video generated by a user device (e.g., smartphone, tablet, camera, action camera) is received.

In process block 310, identification data is received. The identification data corresponds to a sensed parameter (e.g., GPS location) of the user device. The sensed parameter is sensed by the user device while the live stream video is captured by the user device.

In process block 315, at least one database query is performed and the database query includes the sensed parameter data as an argument.

In process block 320, at least one database query response is received and the at least one database query response includes predetermined hashtag data. The predetermined hashtag data may include one or more hashtags.

In process block 325, the predetermined hashtag data is transmitted to a user device (e.g., mobile device, laptop computer, desktop computer, thin-client computing device) for rendering to a display of the user device to prompt a user to select one or more predetermined hashtags corresponding to the predetermined hashtag data.

In an embodiment, the predetermined hashtag data is received in the at least one database query response when the sensed parameter is a geolocation and the geolocation is within a geo-fenced area corresponding to the predetermined hashtag data.

In an embodiment of the process 300, the identification data includes a time stamp of when the live stream video was captured and the at least one database query includes the time stamp as a second argument. Hence, in an embodiment, the time stamp and the geolocation may be included in the database query and the database query response may include the hashtag(s) that correspond to that geolocation and the time stamp.

When the predetermined hashtag is transmitted to the user device, the user may be prompted on the user device to select the one or more hashtags to associate with the live stream video. In one embodiment, the hashtags from the predetermined hashtag data appear on the display of the user device and the user selects (e.g., by pressing on a touch-screen interface of the user device) one of the hashtags to associate with the live stream video that the user is capturing.

In an embodiment, the one or more user-selected hashtags that the user selected from the predetermined hashtags is received. The user-selected hashtags may be received by a server, for example. In an embodiment, the one or more user-selected hashtags is added to transmission metadata of a transmission of the live stream video from the user device to the server. In an embodiment, the one or more user-selected hashtags are added to the transmission metadata of the transmission of the live stream video (e.g., by a server computer) to a second user device (e.g., a second mobile device).

In an embodiment, the live stream video and the corresponding live stream video metadata of the live stream video are received from the user device. The live stream video metadata may include the one or more predetermined hashtags. The live video stream may be streamed to at least one client viewer device (e.g., mobile device) that is subscribed to at least one of the predetermined hashtag(s) of the live stream video metadata.

In an embodiment, the user device is either a smart-phone or a tablet.

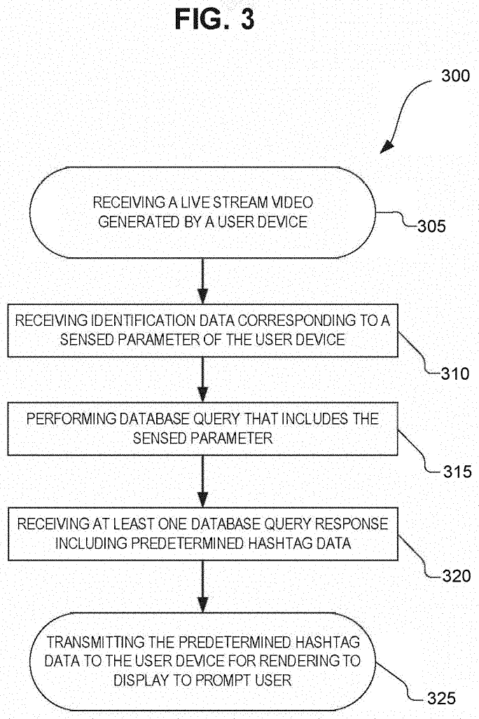

FIG. 4 illustrates an example system 400 for facilitating hashtag prompting, according to an embodiment of the disclosure. In FIG. 4, the system 400 includes a user device 401, a computing device 450, user devices 491A, 491B, and 491C (collectively referred to as 491), and computing device 460. The computing device 450 and/or 460 may be a server computer. The server computers may be located in cloud computing environments or in dedicated data centers. The user devices 491 and 401 may be laptop computers, desktop computers, mobile devices (e.g., tablet, smartphone), or otherwise.

The user device 401 is communicatively coupled to the computing device 450 via communication channel 421, in FIG. 4. In the illustrated embodiment, the user devices 491A, 491B, 491C are communicatively coupled to the computing device 450 via communication channels 471A, 471B, and 471C (collectively referred to as 471), respectively. The computing device 460 is communicatively coupled to the computing device 450 via communication channel 471D, in FIG. 4. Those skilled in the art appreciate that the communication channels 421 and 471 may include wired networks (including the internet) and wireless networks that use IEEE 802.11 protocols, for example.

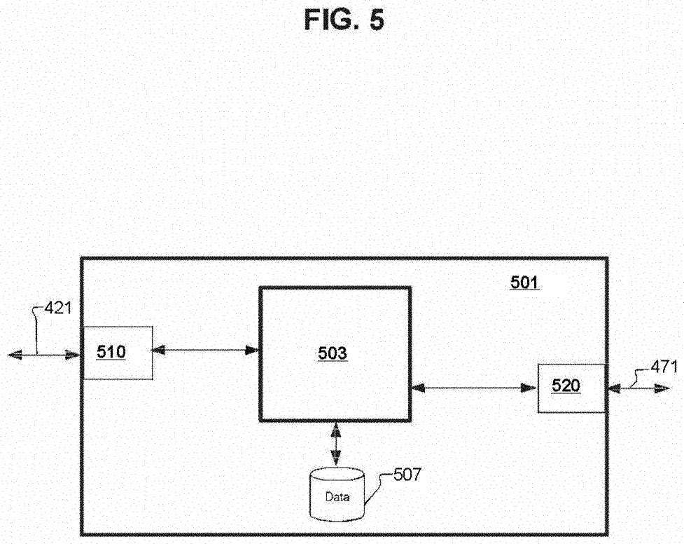

FIG. 5 illustrates an example computing device 501 for facilitating hashtag prompting, according to an embodiment of the disclosure. The computing device 501 may be used for the computing device 450 of FIG. 4, in some embodiments. The computing device 501 includes processing logic 503, database 507, input port 510, and output port 520. The processing logic 503 may include one or more processors, micro-processors, multi-core processors, or FPGAs. The input port 510 and the output port 520 may be integrated into a Network Interface Card (NIC), in an embodiment. The input port 510 is communicatively coupled to the processing logic 503 and receives data from the communication channel 421. The output port 520 is communicatively coupled to the processing logic 503 and transmits to the communication channel 471.

The processing logic 503 is communicatively coupled to the database 507. The database 507 may include predetermined hashtag data. The database 507 may be included in volatile or non-volatile memory included in the computing device 501. In an embodiment, the database 507 is offsite and not physically located within the computing device 501. The database 507 may be included in a separate computer server, for example.

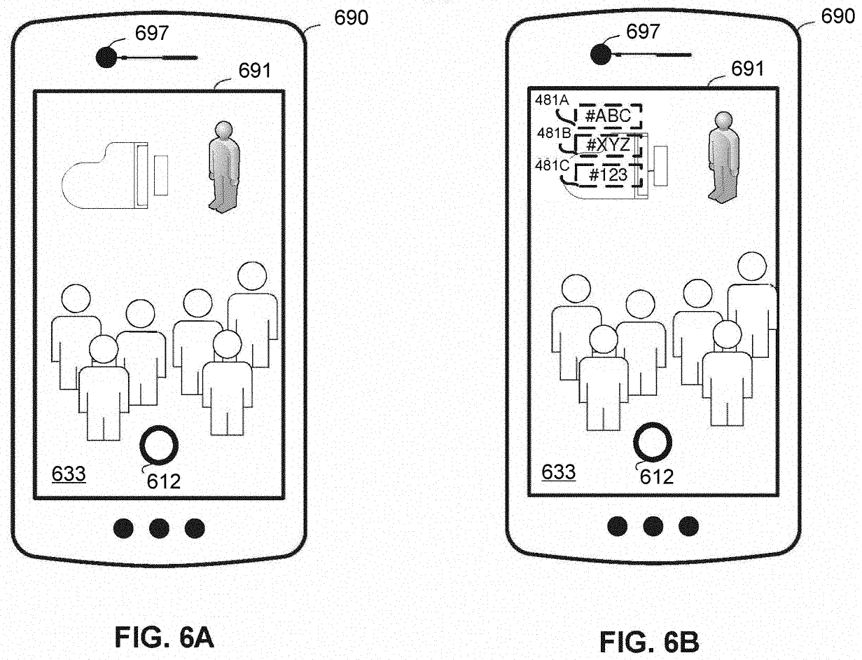

FIGS. 6A and 6B illustrate an example mobile device 690 for facilitating hashtag prompting, according to an embodiment of the disclosure. The mobile device 690 includes a display 691 and a forward-facing camera 697. The mobile device 690 may also include a rear-facing camera 698 (not illustrated). The cameras 697 and 698 may include digital image sensors such as CMOS image sensors. The mobile device 690 may also include a wireless radio to facilitate wireless communications such as BlueTooth, cellular data, or IEEE 802.11 protocols. The mobile device 690 includes processing logic that may include one or more processors, micro-processors, multi-core processors, or FPGAs. The mobile device 690 may also include a memory coupled to the processing logic. The processing logic may be able to read and/or write to the memory, which may be volatile or non-volatile memory. The mobile device 690 may further include a global positioning system (GPS) sensor communicatively coupled to the processing logic where the geolocation is received from the GPS sensor by the processing logic.

In an embodiment, the processing logic is communicatively coupled to a wireless radio and configured to initiate image captures using the image sensor (e.g., of the cameras 697/698) and to receive images from the image sensor. The processing logic may be further coupled to render display images to the display 691 of the mobile device 690.

In an embodiment, the memory of the mobile device 690 includes instructions that when executed, will cause the mobile device 690 to perform operations. The operations may include capturing a video with the image sensor and sensing a geolocation (e.g., GPS coordinate) of the mobile device while the image sensor is capturing the video. In an embodiment, sensing the geolocation may include the mobile device 690 sensing, with the wireless radio, identities of wireless networks and determining the geolocation at least in part by signal strengths of the wireless networks. This technique may involve querying an online database that includes a mapping of local wireless networks.

A user-input to live stream the video as a live stream video may be received by the mobile device 690. For example, a user may press on a software button rendered to the display 691 to initiate a live stream of the video and the mobile device 690 will begin to transmit the video as a live stream video in response to the user-input.

The operations of the mobile device 690 may further include transmitting, using the wireless radio, the live stream video 407 (see FIG. 4) and the geolocation to a computing device. One or more time stamps that were sensed or recorded by the mobile device 690 while the video was being captured may also be transmitted to the computing device. The geolocation and the one or more time stamps may be transmitted in live stream video metadata to the computing device.

The computing device (e.g., a server computer) may use the geolocation and/or time stamp to search a database for hashtags that are associated with geofences and time periods. In an embodiment, when the geolocation is within the geofence and the time period associated with a hashtag, the computing device prepares to send those one or more hashtags back to the user device to prompt the user to select one of the hashtags to link to the live stream video.

The operations of the mobile device 690 may further include receiving hashtags (e.g., hashtags 481A, 481B, and 481C in FIG. 4, collectively referred to as 481) from the computing device, where the hashtags 481A, 481B, 481C correspond to the geolocation location and/or the one or more time stamps.

The mobile device 690 may render the hashtags to the display 691 of the mobile device 690 while the mobile device 690 continues to capture the video and transmit the video as a live stream video.

The mobile device 690 may receive a user-selection (e.g., via a touch-screen interface overlaid over the display 691) of one or more user-selected hashtags from the hashtags 481A, 481B, 481C and transmitting the user-selected hashtags as live stream metadata in the live stream video being transmitted to the computing device.

In the specific illustration of FIG. 6A, a user is capturing a video of an event 633 (e.g., a piano concert). To initiate the video capture, the user may press the record software-button 612. In an embodiment, pressing the button 612 for an extended period of time also initiates a live stream of the captured video. The user may press a second software button (not illustrated) to initiate the live stream of the captured video, in an embodiment. In an embodiment, the mobile device 690 performs operations including rendering a live-stream software button to the display 691 and the user input is a selection of the live-stream software button. The live-stream software button is overlaid on video images of the video being captured that are also rendered to the display 691, in an embodiment.

Initial packets of the live stream video may be sent to a server. The initial packets of the live stream video may include live stream video metadata that includes a GPS location and/or a time stamp of the video capture. The computing device 450 may procure hashtags that are likely to correspond to the location and time of the live stream video and send those hashtags 481 (see FIG. 4) as options for a user to select. FIG. 6B illustrates that the hashtags 481A, 481B, and 481C are rendered to the display 691. In an embodiment, the most relevant hashtag as measured by geolocation and time stamp(s) is presented as the top hashtag (e.g., 481A in the illustrated embodiment).

In an embodiment, rendering the hashtags 481 to the display 691 of the mobile device 690 includes overlaying the hashtags 481 on video images 633 of the video being captured that are also rendered to the display 691.

A user may select the hashtag 481A (illustrated as “#ABC”) by pressing on a software button. Similarly, the user may select the hashtag 481B (illustrated as “#XYZ”) or the hashtag 481C (illustrated as “#123”) by pressing on a software button of those hashtags. Pressing on one or more of the software buttons corresponding to the hashtags 481 will add the hashtag(s) to the live stream video, in an embodiment. The hashtags 481 may be added to the live stream video as metadata that is not included in the video images 633 of the live stream video. In an embodiment, the hashtags 481 are added as viewable hashtags 481 to the live stream video.

Among the advantages and efficiencies of the embodiment of the disclosure is the ability for a user who is live streaming a video to select hashtags in the same application the user is using to facilitate a live stream video without having to exit the application. The features of the disclosure may be incorporated into a social media mobile application, for example. In addition, overlaying the hashtags over the video being captured allows the user to continue looking at the display of the image capture device such as the mobile device 690 to still keep the subject of the video within the frame, while also quickly selecting a relevant hashtag to include in the live stream video. Furthermore, allowing the computing device 450 to procure hashtags for user selection based on the geolocation and/or time stamp of the live stream video allows the user to associate their live stream video with mainstream or popular hashtags so that the user can have their content heard in the “conversation” denoted by the mainstream hashtag. This efficiently groups the “conversations” into more centralized hashtags rather than having the “conversation” fragmented by each user making up their own hashtag for an event. The hashtags provided by the computing device 450 based on geolocation and/or time stamps may be crowd-sourced or seeded to a database by organizers, promoters, or performers of an event.

As described above, the disclosed techniques directed to hashtag prompting can also be applied to other content such as photographs, text, and/or audio content/streaming.

In an embodiment, a method for reducing computer search processing to identify related content includes receiving content generated by a user device and receiving identification data corresponding to a sensed parameter of the user device. In an embodiment, the sensed parameter is sensed by the user device when the content (e.g., photo/video/audio) is captured or transmitted by the user device (to a social media server, for example). In an embodiment, geolocation data and/or time stamp(s) are included in social media content. A status update or post may be just text and not include photos or videos and the text status update may also have the geolocation and the time stamp of where and when the status update was made. The geolocation and the time stamp may be sent from the user device to a computer server along with the text of the status update. A photo, video, or audio recording may also have the time stamp of when the photo/video/audio was captured, and also the geolocation of where it was captured. The geolocation and the time stamp(s) may be sent to a server computer as part of the status update.

In an embodiment, the method further includes performing at least one database query including the sensed parameter data as an argument. In an embodiment, at least one database query response is received that includes predetermined hashtag data. In an embodiment, the predetermined hashtag data is transmitted to the user device for rendering to a display of the user device to prompt a user to select one or more predetermined hashtags corresponding to the predetermined hashtag data.

In an embodiment, the content includes at least one of video, photo, or text. In an embodiment, the method further includes receiving one or more user-selected hashtags that the user selected from the predetermined hashtags. The one or more user-selected hashtags may be added to transmission metadata of a transmission of the content to a second user device.

In an embodiment, the one or more user-selected hashtags is added to the transmission metadata of a transmission of the content to a server.

In an embodiment, the method further comprises receiving the content from the user device and corresponding content metadata to the content. The content metadata may include the one or more predetermined hashtags. The method may further include transmitting the content to at least one client viewer device subscribing to at least one of the predetermined hashtag(s).

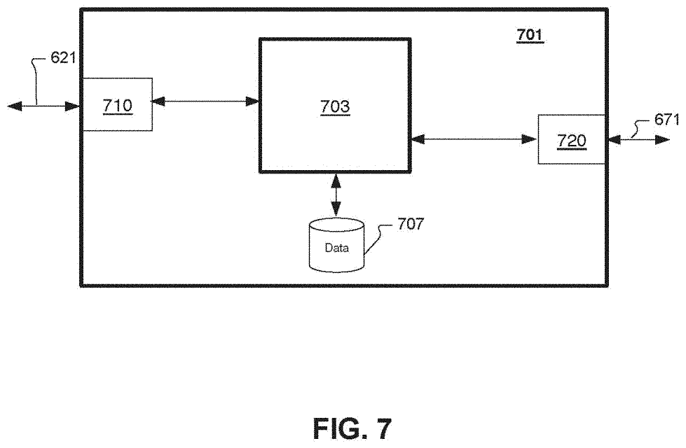

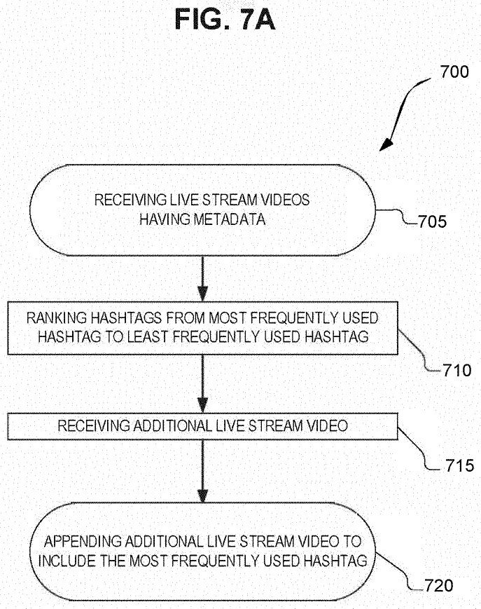

FIG. 7A shows a flow chart illustrating an example process 700 of hashtag assignment, according to an embodiment of the disclosure. In an embodiment, the process 700 is executed by a server computer. The example process 700 relates to live stream video, but similar techniques may be applied to other social media content such as photographs, text, and audio.

In process block 705, live stream videos having metadata are received. The metadata includes hashtags. The metadata in the live stream videos indicate that the live stream videos were captured proximate to a first geolocation and within a first time period, in one embodiment.

In process block 710, the hashtags are ranked from a most frequently used hashtag to a least frequently used hashtag.

In process block 715, additional live stream video is received. The additional live stream video includes additional metadata indicating that the addition live stream video was captured proximate to the first geolocation.

In process block 720, the additional live stream video is appended to include the most frequently used hashtag. In one embodiment, appending the additional live stream video to include the most frequently used hashtag includes adding the most frequently used hashtag to the additional metadata of the additional live stream video. In one embodiment, appending the additional live stream video to include the most frequently used hashtag includes adding the most frequently used hashtag as a viewable artifact to images of the additional live stream video.

In one embodiment, the metadata includes a global positioning system (GPS) location of each of the live stream videos. In one embodiment, being proximate to the first geolocation includes being within a pre-determined geo-fenced area.

In one embodiment, the live stream videos are received from user devices that include at least one of a smartphone or a tablet. The live stream videos and the additional live stream video may be received by a server computer.

In one embodiment, the additional live stream video is appended to include a second-most frequently used hashtag.

In accordance with one embodiment (not illustrated), a method for reducing computer search processing to identify related video content includes receiving a first live stream video generated by a first user device. The first live stream video may include first metadata having a first hashtag. The method further includes receiving a second live stream video generated by a second user device. The second live stream video includes second metadata having a second hashtag, in some embodiments.

The method may further include receiving a third live stream video generated by a third user device. The third live stream video includes third metadata having a third hashtag, and the first, second, and third metadata indicate that the first, second, and third live stream videos were captured proximate to a first geolocation and within a time period, in one embodiment.

The method may further include receiving a fourth live stream video. The fourth live stream video may include fourth metadata. The method may further include appending at least one of the first hashtag, the second hashtag, or the third hashtag to the fourth live stream video when the fourth metadata indicates that the fourth live stream video was captured proximate to the first geolocation.

In accordance with one embodiment (not illustrated), a method of automatically adding hashtags to incoming social media content includes receiving a plurality of social media posts having metadata including hashtags indicating that the social media posts were captured proximate to the first geolocation and within a first time period. The method further includes ranking the hashtags from the most frequently used hashtag to the least frequently used hashtag.

The method further includes receiving an additional social media post having additional metadata indicating that the additional social media post was captured proximate to the first geolocation. The method may further include appending the social media post to include the most frequently used hashtag.

FIG. 7B shows a flow chart illustrating an example process 750 of hashtag assignment, according to an embodiment of the disclosure. In an embodiment, the process 750 is executed by a server computer. The example process 750 relates to live stream video, but similar techniques may be applied to other social media content such as photographs, text, and audio. The process 750 is a method for reducing computer search processing to identify related social media content (e.g., video content), in an embodiment.

In process block 755, a live stream video generated by a user device (e.g., smartphone, tablet, camera, action camera) is received. The live stream video may be received by a server computer, in an embodiment.

In process block 760, identification data is received. The identification data corresponds to a sensed parameter (e.g., GPS location) of the user device. The sensed parameter is sensed by the user device while the live stream video was captured by the user device.

In process block 765, at least one database query is performed and the database query includes the sensed parameter data as an argument.

In process block 770, at least one database query response is received and the at least one database query response include predetermined hashtag data. The predetermined hashtag data may include one or more hashtags.

In process block 775, at least one subscriber of the live stream video is identified based at least in part on the predetermined hashtag data. The at least one subscriber is associated with a hashtag included in the predetermined hashtag data, in an embodiment.

In process block 780, the live stream video is transmitted to at least one subscriber device that is linked to the at least one subscriber.

In an embodiment, the process 750 may further include receiving a first stream request from a first subscriber device among the at least one subscriber device where the live stream video is transmitted to the first subscriber device in response to receiving the first stream request.

In an embodiment, the predetermined hashtag data is received in the at least one database query response when the sensed parameter is a geolocation and the geolocation is within a geofenced area corresponding to the predetermined hashtag data. In an embodiment, the geolocation includes a global positioning system (GPS) location.

In an embodiment, the identification data includes a time stamp of when the live stream video was captured and the at least one database query includes the time stamp as a second argument.

In an embodiment, the user device includes at least one of a smart-phone or a tablet. The at least one subscriber device may include at least one of a mobile device or a server.

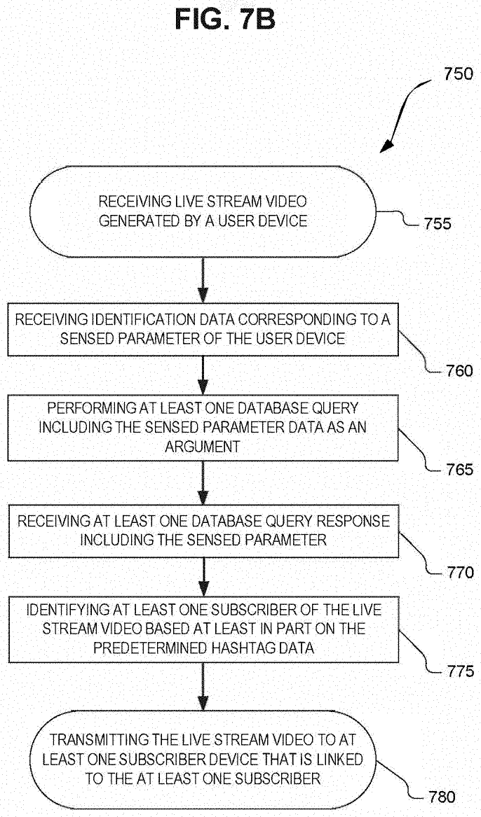

FIG. 8 illustrates an example system 800 for facilitating assignment of hashtags to social media content, according to an embodiment of the disclosure. The social media content may include photographs, videos, live stream video, text, audio or otherwise. In FIG. 8, the system 800 includes user devices 801A-C, a computing device 850, user devices 891A, 891B, and 891C (collectively referred to as 891), and computing device 860. The computing device 850 and/or 860 may be a server computer. The server computers may be located in cloud computing environments or in dedicated data centers. The user devices 891 and 801 may be laptop computers, desktop computers, mobile devices (e.g., tablet, smartphone), or otherwise.

The user devices 801A-C are communicatively coupled to the computing device 850 via communication channels 821A-C, in FIG. 8. In the illustrated embodiment, the user devices 891A, 891B, 891C are communicatively coupled to the computing device 850 via communication channels 871A, 871B, and 871C, respectively. The computing device 860 is communicatively coupled to the computing device 850 via communication channel 871D, in FIG. 8. Those skilled in the art appreciate that the communication channels 821 and 871 may include wired networks (including the internet) and wireless networks that may use IEEE 802.11 protocols, for example. Each of the user devices 801A-C are able to send a social media post 807A-C to the computing device 850 via the communication channels 821A-C, respectively.

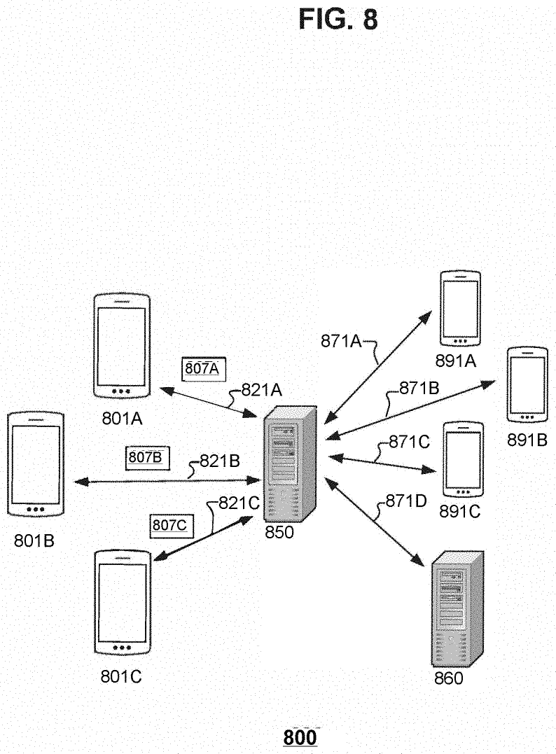

FIG. 9 illustrates an example computing device 901 for facilitating hashtag assignment, according to an embodiment of the disclosure. The computing device 901 may be used for the computing device 850 of FIG. 8, in some embodiments. The computing device 901 includes processing logic 903, database 907, input port 910, and output port 920. The processing logic 903 may include one or more processors, micro-processors, multi-core processors, or FPGAs. The input port 910 and the output port 920 may be integrated into a Network Interface Card (NIC), in an embodiment. The input port 910 is communicatively coupled to the processing logic 903 and receives data from the communication channel 821. The output port 920 is communicatively coupled to the processing logic 903 and transmits to the communication channel 871.

The processing logic 903 is communicatively coupled to the database 907. The database 907 may include event profiles. The database 907 may be included in volatile or non-volatile memory included in the computing device 901. In an embodiment, the database 907 is offsite and not physically located within the computing device 901. The database 907 may be included in a separate computer server, for example.

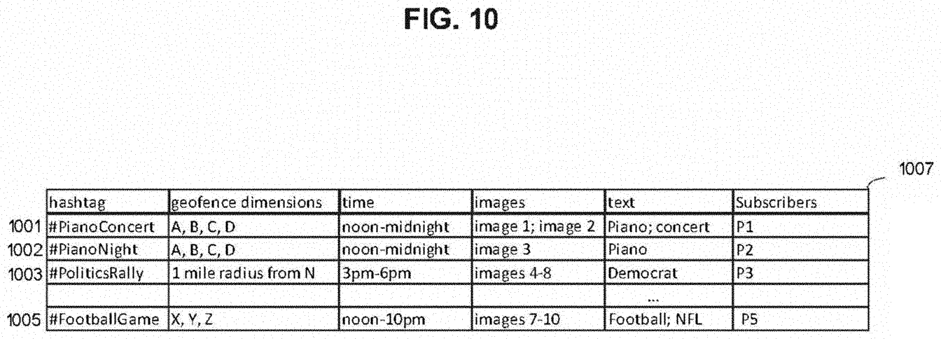

FIG. 10 illustrates a database 1007 that is one example that could be used as database 907 of FIG. 9, according to an embodiment of the disclosure. The database 1007 includes event profiles 1001, 1002, and 1003 through 1005. Each event profile entry in the database 1007 includes geofence dimensions, a time period, images, text, and a subscriber list, in the illustrated embodiment. Other embodiments may not include each of the illustrated components of an event profile.

In an embodiment, at least some of the hashtags, the geofence dimensions, the time period, the images, the text, and the subscribers in an event profile is provided to the database 1007 by a promoter or entertainer. For example, a musician playing a piano concert may seed the database 1007 with an event profile 1001 and 1002 to promote a piano concert the musician is playing. In an example, a football league may seed an event profile (e.g., 1005) with geofence dimensions of a stadium that a game will be played at and the time period that will surround the game. Images of the players, teams, and/or league may be seeded into the event profile 1005 as well. Text keywords that includes the sport, league, players, and teams may be included in the text component of the event profile 1005. Hence, the social media content that is received that is from within the geofence location, within the time period, includes images similar to the pre-seeded images, and/or includes text that is the same or similar to the pre-seeded text keywords may be associated with the hashtag that is included in the event profile (e.g., 1001, 1002, 1005). Pre-seeding components of an event profile within the database 1007 may correspond to pre-planned events.

In an embodiment, one or more components of the event profiles are automatically determined using a crowd-sourcing technique. The crowd-sourcing techniques may be especially useful for unplanned or spontaneous events.

Each event profile (e.g., 1001, 1002, 1003-1005) in FIG. 10 may have images and text keywords that are included in the event profile. A subscriber list to a hashtag of the event profile may also be included in the event profile. In an embodiment, the event profile includes a pointer to a subscriber list. The subscriber list may be physically separated from a computing device that stores the database 1007.

An embodiment of the disclosure includes a method for automatically assigning hashtag metadata to live video stream content and distributing the live video stream content to subscribers according to the automatically assigned hashtag metadata. The method includes capturing a video with a user device (e.g., user device 801 of FIG. 8) and transmitting, from the user device, the video to a computer server (e.g., 850 of FIG. 8) as a live stream video (e.g., content 807 of FIG. 8). The computer server receives the live stream video. The live stream video may include sensed parameters of the user device where the sensed parameters are sensed while the live stream video was captured by the user device. In an embodiment, the sensed parameters are a geolocation and a time stamp indicating where and when the video was captured. The method may further include the computer server performing at least one database query including the sensed parameter data (e.g., geolocation and/or time stamp) as an argument. The database query may be of a database 907/1007 of FIGS. 9-10, for example. The method may further include receiving at least one database query response including predetermined hashtag data. The predetermined hashtag data may include one or more hashtags. In an embodiment, multiple hashtags (e.g., #PianoConcert; #PianoNight) are returned when the geolocation and the time stamp are within the geolocation boundaries and time period of the event profile (e.g., the event profiles 1001 and 1002 of FIG. 10).

The method may further include identifying, by the computer server, at least one subscriber of the live stream video based at least in part on the predetermined hashtag data. In an embodiment, the at least one subscriber is associated with the predetermined hashtag data or hashtag. In the database 1007 of FIG. 10 for example, the subscribers are included in the same event profile as the hashtag.

In an embodiment, the method may further include transmitting, by the computer server, the live stream video to at least one subscriber device (e.g., 891 and/or 860 of FIG. 8) that is linked to the at least one subscriber.

In an embodiment, the method may further include receiving a first stream request from a first subscriber device among the at least one subscriber device. The live stream video may be transmitted to the first subscriber device in response to receiving the first stream request. In an embodiment, the predetermined hashtag data is received in the at least one database query response when the sensed parameter is a geolocation and the geolocation is within a geo-fenced area corresponding to the predetermined hashtag data. The geolocation includes global positioning system (GPS) location, in an embodiment.

In an embodiment, the identification data includes a time stamp of when the live stream video was captured and the at least one database query includes the time stamp as a second argument. In an embodiment, the user device includes at least one of a smart-phone or a tablet. In an embodiment, the at least one subscriber device includes at least one of a mobile device or a server.

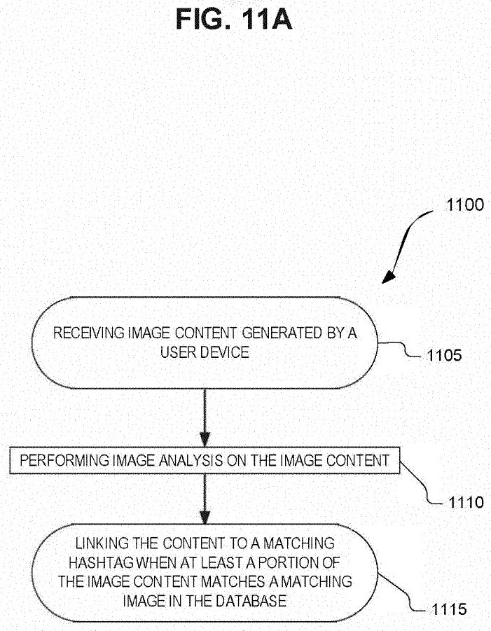

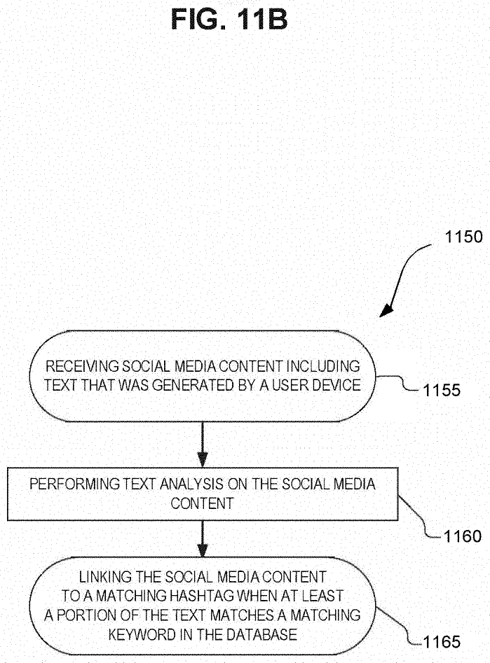

FIG. 11A shows a flow chart illustrating an example process 1100 of hashtag assignment based on images in received content, according to an embodiment of the disclosure. In an embodiment, the process 1100 is executed by a server computer.

In process block 1105, image content generated by a user device (e.g., smartphone, tablet, camera, action camera) is received. The image content may include digital photographs or digital videos, in different embodiments. The image content may be received by the server computer, in an embodiment.

In process block 1110, image analysis is performed on the received image content. The image analysis includes matching a portion of the image content to an image in a database, in an embodiment.

In process block 1115, the image content is linked to a matching hashtag when at least a portion of the image content matches a matching image in the database. The matching hashtag is associated with the matching image. In an embodiment, the matching hashtag and the matching image are included in a same event profile entry of the database.

In an embodiment, performing the image analysis includes comparing frames of a video to the images in the database. In an embodiment, performing the image analysis includes calculating gradients in a digital image of the image content on a pixel-by-pixel basis and comparing the gradients to the images in the database. In an embodiment, performing the image analysis includes detecting edges in the digital image of the image content and comparing the edges to the images in the database.

In an embodiment, the process 1100 further includes identifying at least one subscriber of the image content based at least in part on the matching hashtag and transmitting the image content to at least one subscriber device that is linked to the at least one subscriber. The at least one subscriber may be associated with the matching hashtag. The matching hashtag and a subscriber list including the at least one subscriber may be included in a same event profile entry in the database.

In an embodiment, the process 1100 further includes transmitting the matching hashtag to the user device for rendering to a display of the user device to prompt a user to select the matching hashtag for associating with the image content.

The process 1100 provides a method for linking image content to hashtags based at least in part on the image(s) of the image content. The process 1100 may be used by itself to assign the hashtags to the image content or the social media content that includes the image content. The process 1100 may be used in addition to processes that assign the hashtags to content based on the geolocation and/or time stamp(s) of the content. The geolocation includes a global positioning system (GPS) location, in an embodiment.

FIG. 11B shows a flow chart illustrating an example process 1150 of hashtag assignment based on text in received social media content, according to an embodiment of the disclosure. In an embodiment, the process 1150 is executed by a server computer.

In process block 1155, social media content generated by a user device (e.g., smartphone, tablet, camera, action camera) is received. The social media content includes text and may also include photos, videos, or otherwise. The social media content may be received by the server computer, in an embodiment.

In process block 1160, text analysis is performed on the received image content. The text analysis includes matching at least a portion of the text in the social media content to a matching keyword in a database, in an embodiment.

In process block 1165, the social media content is linked to a matching hashtag when at least a portion of the text of the social media content matches a matching keyword in the database. The matching hashtag is associated with the matching keyword. In an embodiment, the matching hashtag and the matching keyword are included in a same event profile entry of the database.

In an embodiment, the process 1150 further includes identifying at least one subscriber of the social media content based at least in part on the matching keyword and transmitting the social media content to at least one subscriber device that is linked to the at least one subscriber. The at least one subscriber may be associated with the matching hashtag. The matching hashtag and a subscriber list including the at least one subscriber may be included in a same event profile entry in the database.

In an embodiment, the process 1150 further includes transmitting the matching hashtag to the user device for rendering to a display of the user device to prompt a user to select the matching hashtag for associating with the social media content.

The process 1150 provides a method for linking the social media content to hashtags based at least in part on the text of the social media content. The process 1150 may be used by itself to assign the hashtags to the social media content that includes text. The process 1150 may be used in addition to processes that assign the hashtags to the content based on the geolocation and/or time stamp(s) of the content. The process 1150 may be used with the process 900 to link the hashtags to the social media content.

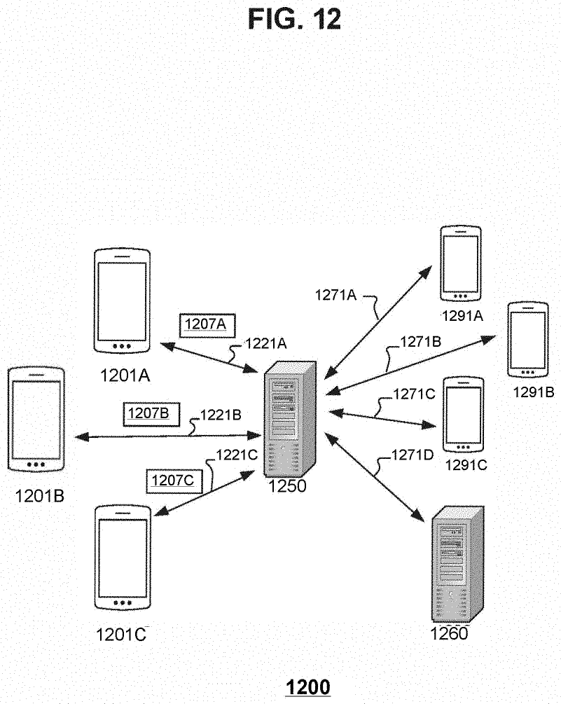

FIG. 12 illustrates an example system 1200 for facilitating assignment of hashtags to social media content, according to an embodiment of the disclosure. The social media content may include photographs, videos, live stream video, text, audio, or otherwise. In FIG. 12, the system 1200 includes user devices 1201A-C, a computing device 1250, user devices 1291A, 1291B, and 1291C (collectively referred to as 1291), and computing device 1260. The computing device 1250 and/or 1260 may be a server computer. The server computers may be located in cloud computing environments or in dedicated data centers. The user devices 1291 and 1201 may be laptop computers, desktop computers, mobile devices (e.g., tablet, smartphone), or otherwise.

The user devices 1201A-C are communicatively coupled to the computing device 1250 via communication channels 1221A-C, in FIG. 12. In the illustrated embodiment, the user devices 1291A, 1291B, 1291C are communicatively coupled to the computing device 1250 via communication channels 1271A, 1271B, and 1271C, respectively. The computing device 1260 is communicatively coupled to computing device 1250 via communication channel 1271D, in FIG. 12. Those skilled in the art appreciate that the communication channels 1221 and 1271 may include wired networks (including the internet) and wireless networks that may use IEEE 802.11 protocols, for example. Each of the user devices 1201A-C are able to send a social media post 1207A-C to the computing device 1250 via the communication channels 1221A-C, respectively.

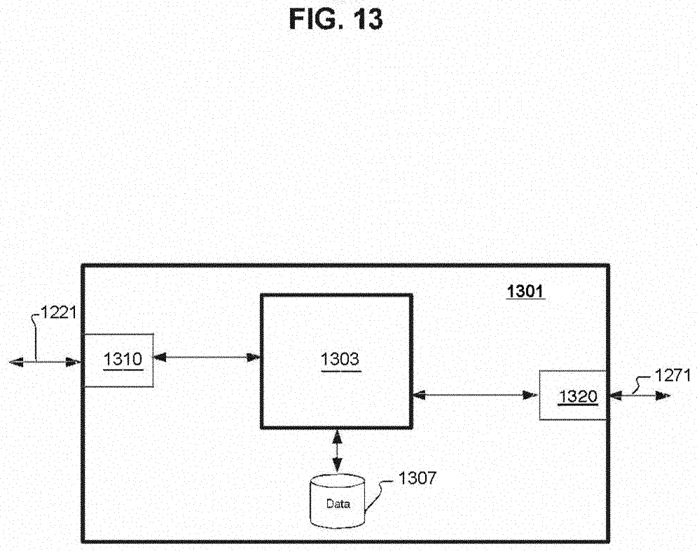

FIG. 13 illustrates an example computing device 1301 for facilitating hashtag assignment, according to an embodiment of the disclosure. The computing device 1301 may be used for the computing device 1250 of FIG. 12, in some embodiments. The computing device 1301 includes processing logic 1303, database 1307, input port 1310, and output port 1320. The processing logic 1303 may include one or more processors, micro-processors, multi-core processors, or FPGAs. The input port 1310 and the output port 1320 may be integrated into a Network Interface Card (NIC), in an embodiment. The input port 1310 is communicatively coupled to the processing logic 1303 and receives data from the communication channel 1221. The output port 1320 is communicatively coupled to the processing logic 1303 and transmits to the communication channel 1271.

The processing logic 1303 is communicatively coupled to the database 1307 and the processing logic 1303. The database 1307 may include event profiles. The database 1307 may be included in volatile or non-volatile memory included in the computing device 1301. In an embodiment, the database 1307 is offsite and not physically located within the computing device 1301. The database 1307 may be included in a separate computer server, for example.

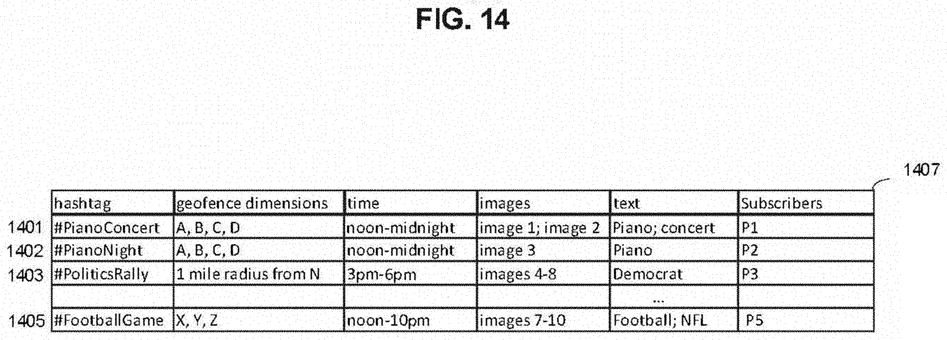

FIG. 14 illustrates a database 1407 that is one example that could be used as the database 1307 of FIG. 13, according to an embodiment of the disclosure. The database 1407 includes event profiles 1401, 1402, and 1403 through 1405. Each event profile entry in the database 1407 includes geofence dimensions, a time period, images, text, and a subscriber list, in the illustrated embodiment. Other embodiments may not include each of the illustrated components of an event profile.

In an embodiment, at least some of the hashtags, the geofence dimensions, the time period, the images, the text, and the subscribers in an event profile is provided to the database 1407 by a promoter or entertainer. For example, a musician playing a piano concert may seed the database 1407 with an event profile 1401 and 1402 to promote a piano concert the musician is playing. In an example, a football league may seed an event profile (e.g., 1405) with geofence dimensions of a stadium that a game will be played at and the time period that will surround the game. Images of the players, teams, and/or league may be seeded into the event profile 1405 as well. Text keywords that includes the sport, league, players, and teams may be included in the text component of the event profile 1405. Hence, social media content that is received that is from within the geofence location, within the time period, includes images similar to the pre-seeded images, and/or includes text that is the same or similar to the pre-seeded text keywords may be associated with the hashtag that is included in the event profile (e.g., 1401, 1402, 1405). Pre-seeding components of an event profile within the database 1407 may correspond to pre-planned events.

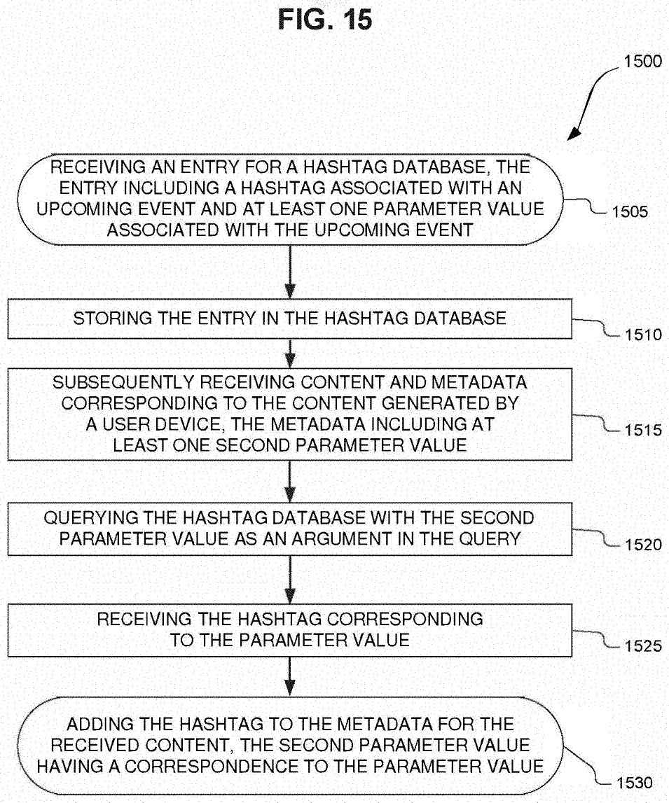

FIG. 15 shows a flow chart illustrating an example process 1500 of populating and utilizing a database with hashtags for a pre-planned event, according to an embodiment of the disclosure.

In process block 1505, an entry for a hashtag database is received. The entry may include a hashtag associated with an upcoming event and at least one parameter value associated with the upcoming event.

In process block 1510, the entry is stored in the hashtag database.

In process block 1515, subsequently to process blocks 1510, content and metadata is received corresponding to the content generated by a user device. The metadata includes at least one second parameter value.

In process block 1520, the hashtag database is queried with the second parameter value as an argument in the query.

In process block 1525, the hashtag corresponding to the parameter value is received.

In process block 1530, hashtag to the metadata for the received content is received. The second parameter value has a correspondence to the parameter value.

In one embodiment, the at least one parameter value associated with the upcoming event is a geofence dimension and the upcoming event is within the geofence dimension.

In one embodiment, the at least one parameter value associated with the upcoming event is a time of the upcoming event and the upcoming event is within the time.

In one embodiment, the at least one parameter value associated with the upcoming event is an image associated with the upcoming event.

In one embodiment, the at least one parameter value associated with the upcoming event is text associated with the upcoming event.

In one embodiment, the entry for the hashtag database is received from an owner or performer of the upcoming event.

In some embodiments, one or more components of the event profiles are automatically determined using a crowd-sourcing technique. The crowd-sourcing techniques may be especially useful for unplanned or spontaneous events.

Each event profile in FIG. 14 (e.g., 1401, 1402, 1403 through 1405) also has images and text keywords that are included in the event profile. A subscriber list to a hashtag of the event profile may also be included in the event profile. In an embodiment, the event profile includes a pointer to a subscriber list. The subscriber list may be physically separated from a computing device that stores the database 1407.

An embodiment of the disclosure includes a method for automatically assigning a hashtag to social media content and distributing the social media content to subscribers according to the automatically assigned hashtag. The method includes generating a social media post from a user device (e.g., the user device 1201 of FIG. 12) and transmitting, from the user device, the social media content (e.g., 1207 of FIG. 12) to a computer server (e.g., 1250 of FIG. 12). The computer server receives the social media content. The social media content may include sensed parameters of the user device where the sensed parameters are sensed while the social media content is transmitted to the computer server. In an embodiment, the sensed parameters are a geolocation and a time stamp indicating where and when the social media content was transmitted. The method may further include the computer server performing at least one database query including the sensed parameter data (e.g., geolocation and/or time stamp) as an argument. The method may further include the computer server performing at least one database query including the text or image content of the social media content as another argument. The database query may be of the database 1307/1407 of FIGS. 13-14, for example. The method may further include receiving at least one database query response including a matching hashtag that matches all the arguments submitted. In an embodiment, multiple hashtags (e.g., #PianoConcert; #PianoNight) are returned when the geolocation and an image or text of the social media are within the geolocation boundaries and the image or text is a matching image or matching keyword of the event profile (e.g., event profiles 1401 and 1402 of FIG. 14).

The method may further include identifying, by the computer server, at least one subscriber of the social media content based at least in part on the matching hashtag. In an embodiment, the at least one subscriber is associated with the matching hashtag. In the database 1407, for example, the subscribers are included in the same event profile as the matching hashtag.

In an embodiment, the method may further include transmitting, by the computer server, the social media content to at least one subscriber device (e.g., 1291 and/or 1260 of FIG. 12) that is linked to the at least one subscriber.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. A computer method, comprising:
identifying, with a message augmentation system, message characteristics associated with a plurality of messages;
recording, with the message augmentation system, the message characteristics on one or more non-transitory computer readable memories;
identifying one or more characteristics of a current message of a user of the message augmentation system by analyzing the current message with the message augmentation system;
identifying, with the message augmentation system, a candidate message augmentation for the current message by querying the one or more non-transitory computer readable memories based on the characteristics of the current message; and
assisting the user to augment the current message with the candidate message augmentation.

2. The computer method of claim 1, wherein recording, with the message augmentation system, the message characteristics on one or more non-transitory computer readable memories includes recording, with the message augmentation system, the message characteristics in one or more computer readable memory locations identified by one or more blockchain transactions; and
wherein identifying, with the message augmentation system, a candidate message augmentation for the current message by querying the one or more non-transitory computer readable memories based on the characteristics of the current message includes identifying, with the message augmentation system, a candidate message augmentation for the current message by querying the one or more computer readable memory locations identified by the one or more blockchain transactions based on the characteristics of the current message.

3. The computer method of claim 2, wherein the one or more blockchains include a public blockchain.

4. The computer method of claim 2, wherein the one or more computer readable memory locations include a distributed file system

5. The computer method of claim 1, wherein identifying the candidate message augmentation includes:
selecting one or more characteristics of the current message;
identifying one or more messages from the one or more computer readable memories that include characteristics related to the one or more characteristics of the current message; and
identifying, from the one or more messages from the one or more computer readable memories, content not yet included in the current message that may be relevant to include in the current message.

6. The computer method of claim 1, wherein assisting the user to augment the current message includes prompting the user to add the candidate message augmentation to the current message.

7. The computer method of claim 1, wherein assisting the user to augment the current message includes:
prompting the user to approve the candidate message augmentation; and
augmenting the current message with the candidate message augmentation upon receiving approval from the user.

8. The computer method of claim 1, wherein assisting the user to augment the current message includes automatically augmenting the current message for the user.

9.-11. (canceled)

12. The computer method of claim 1, wherein the messages include messages sent from a plurality of different messaging applications.

13. The computer method of claim 1, further comprising assisting the user to augment the current message with the candidate message augmentation before the current message has been sent.

14. The computer method of claim 1, further comprising updating the blockchain with content from the current message after the current message has been augmented with the candidate message augmentation and after the current message has been sent.

15. The computer method of claim 1, wherein the message characteristics include content metadata associated with the messages.

16. The computer method of claim 1, wherein the message characteristics include message labels.

17. The computer method of claim 16, wherein the message labels include hashtags.

18. The computer method of claim 16, wherein the candidate message augmentation includes a hashtag.

19. The computer method of claim 1, wherein the message characteristics include locations associated with the messages.

20. The computer method of claim 19, wherein identifying the candidate message augmentation includes:
identifying a current location of the user; and
identifying one or more common message characteristics of messages sent by other users from the current location of the user.

21. The computer method of claim 19, wherein identifying the candidate message augmentation includes identifying the one or more common message characteristics of messages sent by other users from the current location of the user within a selected recent timeframe.

22. The computer method of claim 1, wherein identifying the candidate message augmentation includes:
identifying the current location of the user; and
identifying the one or more common message characteristics of messages sent previously by the user from the current location.

23.-27. (canceled)

28. The computer method of claim 1, wherein the message characteristics include at least one of nouns, verbs, subjects of phrases, objects of phrases, and subjects of sentences included in the text of the messages.

29-133. (canceled)
